(19) United States
(12) Patent Application Publication
(10) Pub. No.: US 2004/0242210 A1
(43) Pub. Date: Dec. 2, 2004

(54) System and method for communication of visual messages

(76) Inventors: Roberto Tagliabue, Boston, MA (US); Marco Susani, Boston, MA (US)

Correspondence Address: MOTOROLA INC, 600 NORTH US HIGHWAY 45, ROOM AS437, LIBERTYVILLE, IL, 60048-5343, US

(21) Appl. No.: 10/447,818

(22) Filed: May 29, 2003

(51) Int. Cl. H04Q 7/20

(52) U.S. Cl. 455/414.4; 455/414.1; 455/414.3

(57) ABSTRACT

The invention is a server (110) for communicating with a plurality of communication devices (102), and a method thereof. The server (110) comprises a network interface (306) and a processor (302) coupled to the network interface. The network interface (306) receives an incoming message from a source device (602) and sends an outgoing message to one or more destination devices (606, 608, 610). The incoming message includes a media, such as image data, video data and/or audio data. The outgoing message includes a visual representation of the media, such as a reduced version of the media. In the alternative, the outgoing message is similar to the incoming message. The processor (302) associates the media with a space. The space is a grouping of media associated with a particular group of communication entities, such as communication devices (102) and/or users. An incoming message is received from a source device (802, 1002), and the media is associated with a space. An outgoing message is then sent to the one or more destination devices (806, 808, 810, 1006, 1008, 1010).

### FIELD OF THE INVENTION

The present invention relates generally to the field of communication networks having messaging capabilities. In particular, the present invention relates to the field of messaging services for communication devices having the capability of communicating images, video, and/or multimedia.

### BACKGROUND OF THE INVENTION

Various forms of messaging are available, such as email messaging systems, instant messaging systems, short messaging systems, and multimedia messaging systems. These existing messaging systems provide an efficient conduit for communication of text information. These systems also provide the capability of attaching supplemental information, such as images and sounds, to the text information. In other words, the primary focus of each message is the text information, and secondary consideration is given to other types of information.

Unfortunately, existing messaging systems utilize the simple model of text-centric messaging, described-above, which is technical, dry and hyper efficient. Rich content, such as images, video and/or audio, is considered to be supplemental and, thus, are mere attachments to the text-centric messages. In other words, efficiency is valued more than the content of the communication.

There is a need for a messaging system that focuses on rich content, such as image, video and/or audio, instead of text. In addition, there is a need for a messaging system, and a method thereof, that conglomerates rich content of certain users and their respective devices to promote an effective form of communication.

### BRIEF DESCRIPTION OF THE DRAWINGS

FIG. 1 is a perspective view of a preferred embodiment in accordance with the present invention.

FIG. 2 is a block diagram representing an exemplary representation of one or more communication devices of FIG. 1.

FIG. 3 is a block diagram representing an exemplary representation of the server of FIG. 1.

FIG. 4 is a conceptual diagram of communication among a plurality of communication devices in accordance with the present invention.

FIG. 5 is another conceptual diagram of communication among a plurality of communication devices in accordance with the present invention.

FIGS. 6 and 7 are conceptual diagrams representing a first preferred operation of the server and communication devices of FIG. 1.

FIGS. 8 and 9 are conceptual diagrams representing a second preferred operation of the server and communication devices of FIG. 1.

FIGS. 10 and 11 are conceptual diagrams representing a third preferred operation of the server and communication devices of FIG. 1.

FIG. 12 is a flow diagram representing the first preferred operation of FIGS. 6 and 7.

FIG. 13 is a flow diagram representing the second preferred operation of FIGS. 8 and 9.

FIG. 14 is a flow diagram representing the third preferred operation of FIGS. 10 and 11.

### DETAILED DESCRIPTION OF THE PREFERRED EMBODIMENTS

For one preferred embodiment, the present invention is a server for communicating with a plurality of communication devices, and a method thereof. The server comprises a network interface and a processor coupled to the network interface. The network interface receives an incoming message from a source device and sends an outgoing message to one or more destination devices. The incoming message includes a media, such as image data, video data, audio data and/or any combination of such data. The outgoing message includes a visual representation of the media, such as a reduced version of the media. The processor associates the media with a space. The space is a grouping of media associated with a particular group of communication entities, such as communication devices and/or users. An incoming message is received from a source device, and the media is associated with a space. An outgoing message is then sent to the one or more destination devices.

For other preferred embodiments, the network interface of the server receives a message from a source device and forwards the message to one or more destination devices. The message includes a media, such as image data, video data, audio data and/or any combination of such data. The processor associates the media with a space. As stated above, the space is a grouping of media associated with a particular group of communication entities, such as communication devices and/or users. A message is received from a source device, the media is associated with a space. The message is then forwarded to the one or more destination devices.

Although the embodiments disclosed herein are particularly well suited for use with a cellular telephone, persons of ordinary skill in the art will readily appreciate that the teachings of this disclosure are in no way limited to cellular telephones. On the contrary, persons of ordinary skill in the art will readily appreciate that the teachings of this disclosure can be employed with any wireless communication device such as a pager, a personal digital assistant (“PDA”), a wireless communication-capable still image camera, a wireless communication-capable video camera, and the like.

The wireless communication system in accordance with the present invention is described in terms of several preferred embodiments, and particularly, in terms of a wireless communication system operating in accordance with at least one of several standards. These standards include analog, digital or dual-mode communication system protocols such as, but not limited to, the Advanced Mobile Phone System (“AMPS”), the Narrowband Advanced Mobile Phone System (“NAMPS”), the Global System for Mobile Communications (“GSM”), the IS-55 Time Division Multiple Access (“TDMA”) digital cellular system, the IS-95 Code Division Multiple Access (“CDMA”) digital cellular system, CDMA 2000, the Personal Communications System (“PCS”), 3G, the Universal Mobile Telecommunications System (“UMTS”), and variations and evolutions of these protocols. The wireless communication system in accordance with the present invention may also operate via an ad hoc network and, thus, provide point-to-point communication with the need for intervening infrastructure. Examples of the communication protocols used by the ad hoc networks include, but are not limited to, IEEE 802.11a, IEEE 802.11b, IEEE 802.11 g, Bluetooth, and infrared technologies.

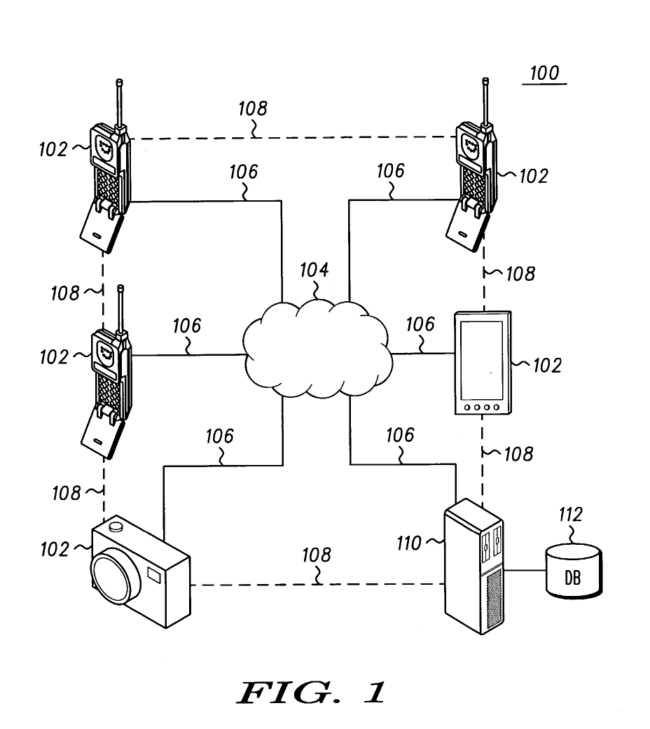

Referring to FIG. 1, there is shown a communication system 100 in accordance with the present invention. The communication system 100 includes a plurality of communication devices 102 communicating with each other. For one embodiment of the system 100, the plurality of communication devices 102 may communicate through a communications network 104 via network connections 106 as shown in FIG. 1. For another embodiment of the system 100, the plurality of communication devices 102 may communicate with each other directly via direct links 108, i.e., a point-to-point or ad hoc network. Accordingly, the communication devices 102 may communication with a server 110 via the communication network 104 or via the point-to-point or ad hoc network. For the point-to-point or ad hoc network, the communication devices 102 may communicate with the server 110 directly or indirectly through a repeater, such as an intervening communication device.

The communication system 100 may employ any communication device having image and/or video recording capabilities. Examples of communication devices 102 that may have image and/or video recording capabilities include, but are not limited to, personal digital assistants (“PDA's”), cellular telephones, radiophones, handheld computers, small portable/laptop/notebook/sub-notebook computers, tablet computers, hybrid communication devices, still image cameras having wireless communication capabilities, video cameras having wireless communication capabilities, and the like.

The communication system 100 also includes a messaging application for operating a messaging system among the communication devices 102. For one embodiment, the messaging application may be operated by the server 110 and an associated database 112 that communicate through the communication network 104 via the network connections 106, communicate with the communication devices 102 directly via direct links 108, or a combination thereof. For another embodiment, the messaging application may be operated by one of the communication devices 102 communicating with other communication devices, or distributed among a plurality of communication devices, that communicate through the communication networks 104 via the network connections 106, communicate directly via direct links 108, or a combination thereof.

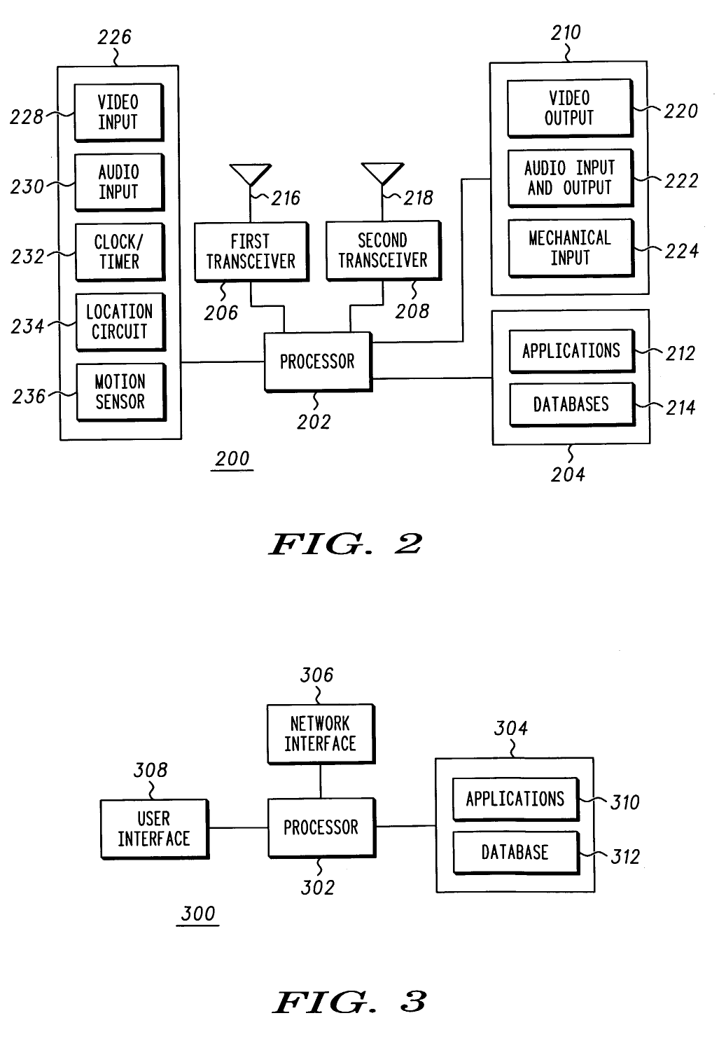

FIG. 2 shows various exemplary components that may be utilized by each communication device 102 of the communication system 100. Each communication device 102 may include a processor 202 and a memory 204, one or more transceivers 206, 208, and a user interface 210 that are coupled together for operation of the respective communication device. It is to be understood that two or more of these internal components 200 may be integrated within a single package, or functions of each internal component may be distributed among multiple packages, without adversely affecting the operation of each communication device 102.

As stated above, each communication device 102 includes the processor 202 and the memory 204. The processor 202 controls the general operation of the communication device 102 including, but not limited to, processing and generating data for each of the other internal components 200. The memory 204 may include an applications portion 212, and/or a database portion 214. The applications portion 212 includes operating instructions for the processor 202 to perform various functions of the communication device 102. A program of the set of the operating instructions may be embodied in a computer-readable medium such as, but not limited to, paper, a programmable gate array, flash memory, application specific integrated circuit (“ASIC”), erasable programmable read only memory (“EPROM”), read only memory (“ROM”), random access memory (“RAM”), magnetic media, and optical media. The database portion 214 stores data that is utilized by the applications stored in the applications portion 212. For the preferred embodiment, the applications portion 212 is non-volatile memory that includes a client application 216 for communicating with a main application operated at a remote device, and the database portion 214 is also non-volatile memory that stores data in a database that is utilized by the client application and associated with the communication device 102 or user of the communication device. In the alternative, a messaging system, or a portion thereof, may be stored in the memory 204 of a particular communication device 102.

Each communication device 102 also includes one or more transceivers 206, 208. Each transceiver 206, 208 provides communication capabilities with other entities, such as the communication network 104 and/or other communication devices 102. For the preferred embodiment, each transceiver 206, 208 operates through an antenna 216, 218 in accordance with at least one of several standards including analog, digital or dual-mode communication system protocols and, thus, communicates with appropriate infrastructure. However, as referenced above, each transceiver 206, 208 may also provided point-to-point communication via an ad hoc network.

Each communication device 102 also includes the user interface 210. The user interface 210 may include a visual interface 220, an audio interface 222 and/or a mechanical interface 224. Examples of the visual interface 220 include displays and cameras, examples of the audio interface 222 include speakers and microphones, and examples of the mechanical interface 224 includes keypads, touch pads, touch screens, selection buttons, vibrating mechanisms, and contact sensors. For example, a user may utilized the user interface 210 to provide input to be shown on a display and make selections for the display by using mechanical instructions, e.g., touching a touch pad overlapping the display, keypad keys or selection buttons, or providing audible commands and data into a microphone. For all preferred embodiments of the present invention, each communication device 102 includes a display to provide output information associated with the messaging system to corresponding users. On the other hand, alternative embodiments may include other types of output devices, audio or mechanical, to provide output to users.

Each mobile station 102 may further include a sensor 226. The sensor 210 detects one or more information or events of its corresponding mobile station 102 with or without user intervention. For the preferred embodiment, each mobile station 102 includes a video input 228 and may optionally include one or more of the following additional sensors: an audio input 230, a clock/timer 232, a location circuit 234, and a motion sensor 236. The video input 228 provides static images or dynamic video to the other components of the mobile station 102. Examples of the video input 228 include, but are not limited to, a still-image camera, a video camera, and the like. The clock/timer 232 may detect or track a current time of the mobile station 102, and detect or tracks an elapsed time in relation to a given time. The location circuit 234 detects a location of the mobile station based on internal circuitry, via an external source, or both. Examples of the location circuit 234 include, but are not limited to, a global positioning system (GPS), a beacon system, and a forward link trilateration (FLT) system. The motion sensor 236 detects orientations or movements of the mobile station 102 as it is operated by its user. Examples of the motion sensor 236 include, but are not limited to, an accelerometer, a gyroscope, and the like.

Referring to FIG. 3, the server 110 communicates with, or is part of, the communication network 104 and includes various internal components 300. It is to be understood that communication devices 102 may communicate with each other directly or through the communication network 104 without accessing the server 110 and, thus, the server is not required for proper operation in accordance with the present invention. For example, each communication device 102 may communication with a main application located at another communication device instead of an application located at the server 110. The server 110 includes a processor 302 and a memory 304, and a network interface 306 that are coupled together for operation of the server. Optionally, the server 110 may also include a user interface 308 for interactive input and output of information with a user when installing, operating and/or maintaining the server. It is to be understood that two or more of these internal components 300 may be integrated within a single package, or functions of each internal component may be distributed among multiple packages, without adversely affecting the operation of the server 110.

As stated above, the server 110 includes the processor 302 and the memory 304 and operates similarly to the processor 202 and the memory 204 of each communication device 102. The processor 302 controls the general operation of the server 110 including, but not limited to, processing and generating data for each of the other internal components 300. A program of the set of the operating instructions may be embodied in a computer-readable medium such as, but not limited to, paper, a programmable gate array, flash memory, ASIC, EPROM, ROM, RAM, magnetic media, and optical media. The memory 304 may include an applications portion 310 and a database portion 312. The applications portion 310 includes operating instructions for the processor 302 to perform various functions of the server 110. The database portion 312 stores data that is utilized by the applications stored in the applications portion 310. For example, the applications portion 310 is non-volatile memory that may include a main application for communicating with a client application operated at one or more communication devices 102, and the database portion 312 is also non-volatile memory that stores data utilized by the main application and associated with the communication devices, the users of the communication devices, and/or the server 110.

The server 110 may be operatively coupled to a database within the database portion 312 and coupled to, or integrated in, the communication network 104. The server 110 may operate as a central server from the communication network 104 to provide the main application as described herein. Alternatively, the main application may be communication device-centric and reside in an applications portion 212 of at least one of the plurality of communication devices 102. That is, one of the communication devices 102 may act as a host communication device or several communication devices may act in conjunction with each other to operate the main application as described herein. In either case, each communication device 102 that does not include the main application would have a client application that communicates with the main application. If a communication device 102 includes the main application, that particular communication device may or may not include a client application.

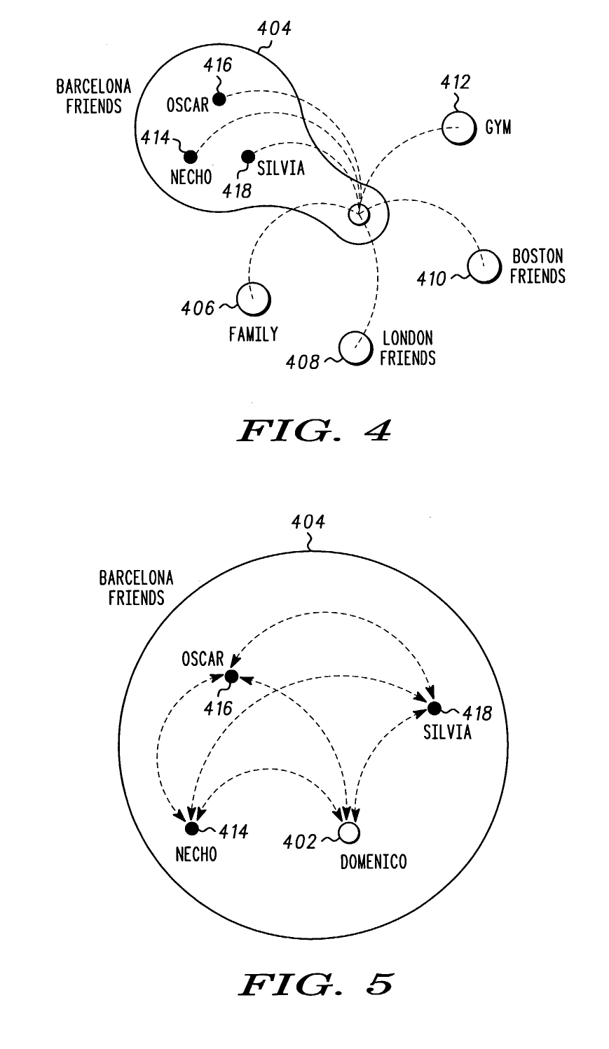

Referring to FIG. 4, there is provided a conceptual diagram of communication among a plurality of communication devices 102 in accordance with the present invention. In particular, a communication device may communicate within one or more spaces. Each space, in accordance with the present invention, is a grouping of media, such as an image, video and/or audio, associated with a particular group of communication entities, such as communication devices 102 and/or users. Combinations of such capabilities include, but are not limited to, image plus audio and video plus audio capabilities. The particular group must include multiple communication devices, i.e., two or more devices, but may include a potentially unlimited number of devices.

For example, as shown in FIG. 4, a communication device, i.e., Domenico's device 402, operated by Domenico may communicate within a plurality of spaces, namely a Barcelona Friends space 404, a Family space 406, a London Friends space 408, a Boston Friends space 410, and a Gym space 412. Each space includes a plurality of users or devices. For example, the Barcelona Friends space 404 includes Domenico's device 402, Necho's device 414, Oscar's device 416 and Silvia's device 418 who are friends of Domenico and are associated with the city of Barcelona. Likewise, the Family space 406 includes users or devices associated with Domenico's family, the London Friends space 408 includes users or devices who are friends of Domenico and are associated with the city of London, the Boston Friends space 410 includes users or devices who are friends of Domenico and are associated with the city of Boston, and the Gym space 412 are associated with one or more athletic clubs. At any given time, Domenico's device 402 is associated with a particular space and any broadcasts by Domenico's device at that given time will be directed to the particular space. As shown in FIG. 4, Domenico's device 402 is associated with the Barcelona Friends space 404 and, thus, the Barcelona Friends space is the current space of Domenico's device. Unless the current space of Domenico's device 402 changes, the next message broadcast by Domenico's device will be sent to Necho's device 414, Oscar's device 416 and Silvia's device 418.

Referring to FIG. 5, there is provided a conceptual diagram of communication among a plurality of communication devices within a single space. One communication device may broadcast messages to all other devices in the space. For example, as shown by the Barcelona Friends space 402 of FIG. 5, any message sent by Domenico's device 402 will be broadcast to Necho's device 414, Oscar's device 416 and Silvia's device 418. In this manner, messaging is simplified for each device within a particular space, because the recipients of any given message is predetermined so long as the current space of the originator is clearly identified. It is to be understood that the communication among devices is performed through a server, as described below, and thus FIGS. 4 and 5 should not be interpreted to represent broadcasts of messages associated with the current space directly to the other devices of the space.

Referring to FIGS. 6 and 7, there are provided conceptual diagrams representing a first preferred operation of the server 110 and communication devices 102. For the first preferred operation, all messages and/or media associated with the current space are stored on the server 110 or, more particularly, the database 112 associated with the server. It is to be understood that, for all embodiments described herein, messages includes a media such as image information, video information and/or audio information. As shown by FIG. 6, a source device 602 may send an incoming message that includes one or more media to the server 604. The server 604 may associate the media of the message with a particular space. The incoming message and/or the included media are stored at the server 604. Then, as shown by FIG. 7, the server 604 may send an outgoing message to the destination devices 606, 608, 610 of the particular space. For the preferred embodiments, the destination devices 606, 608, 610 are all communication devices 102 of the particular space except for the source device 602. The outgoing message includes a visual representation of the media included with the incoming message. For example, the visual representation may be a reduced version or thumbnail of the media. Additional information may be included with the outgoing message such as a link to the media stored at the server 604.

Referring to FIGS. 8 and 9, there are provided conceptual diagrams representing a second preferred operation of the server 110 and communication devices 102. For the second preferred operation, all messages and/or media associated with the current space are stored by the communication devices 102. As shown by FIG. 8, a source device 802 may send an incoming message that includes one or more media to the server 804. The server 804 may associate the media of the message with a particular space. Then, as shown by FIG. 9, the server 804 may forward the incoming message, the included media, or a visual representation of the media to the destination devices 806, 808, 810 of the particular space. Each communication device 802, 806, 808, 810 stores all received messages, media and/or representations associated with the particular space. Again, the visual representation may be, for example, a reduced version or thumbnail of the media.

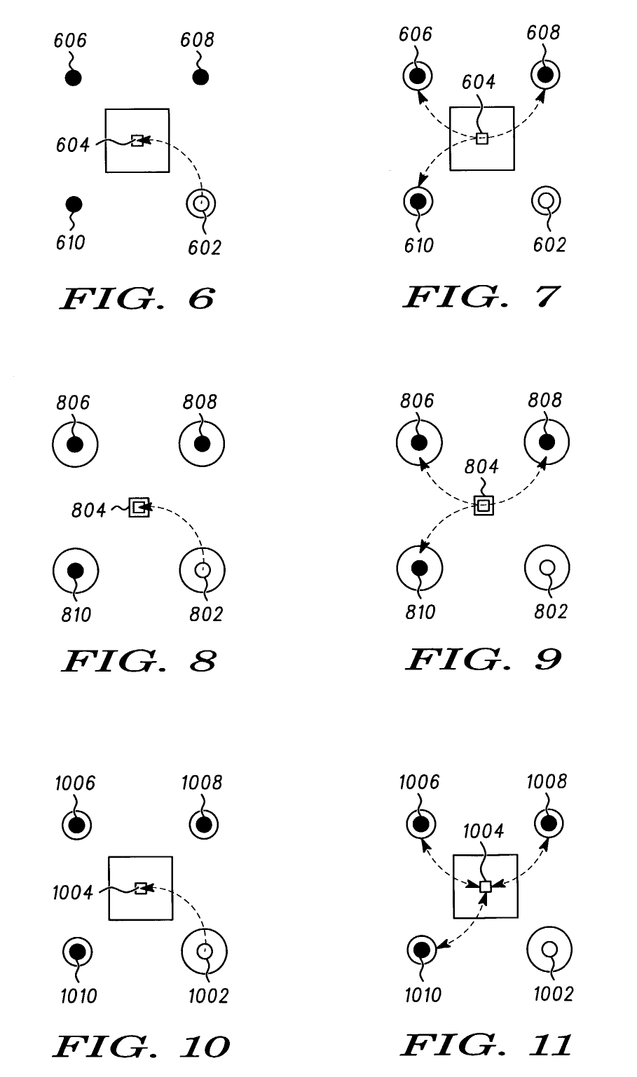

Referring to FIGS. 10 and 11, there are provided conceptual diagrams representing a third preferred operation of the server 110 and communication devices 102. For the third preferred operation, some messages and/or media associated with the current space are stored by the communication devices 102 whereas other message and/or media associated with the current space are stored by the server 110. In particular, the communication devices 102 store the most recent message and/or media whereas the server 110 hosts all media of the current space. As shown by FIG. 10, a source device 1002 may send an incoming message that includes one or more media to the server 1004. The server 1004 may associate the media of the message with a particular space. The incoming message and/or the included media are stored at the server 1004. Then, as shown by FIG. 11, the server 1004 may forward the incoming message, the included media, or a visual representation of the media to the destination devices 1006, 1008, 1010 of the particular space. Since the server 1004 retains all messages, media and/or representations associated with the particular space, it is not necessary for the communication devices 1002, 1006, 1008, 1010 to store any of the received messages, media and/or representations except for the most recent ones. Again, the visual representation may be, for example, a reduced version or thumbnail of the media.

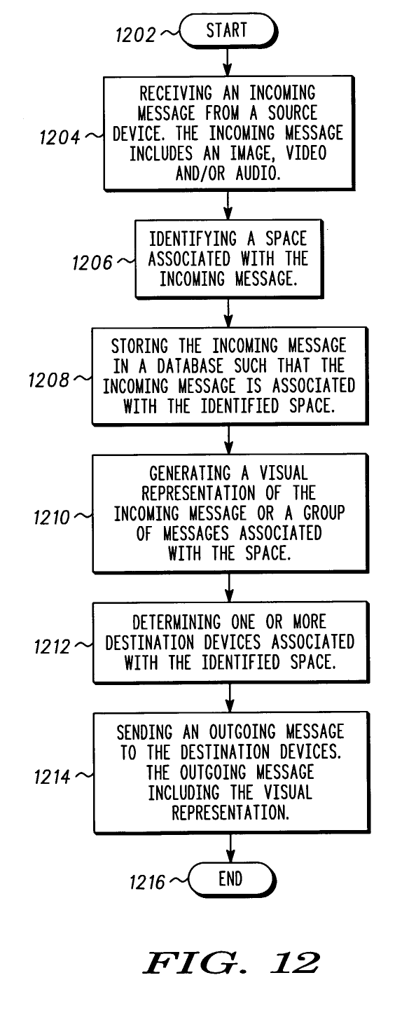

Referring to FIG. 12, there is provided a flow diagram representing the first preferred operation. For the first preferred operation, beginning at step 1202, the processor 302 of the server 604 may receive an incoming message from a source device 602 at step 1204. The incoming message includes image information, video information and/or audio information. Next, the server 604 may identify a space associated with the incoming message at step 1206. The server 604 may then store the incoming message and/or the media included with the incoming message in a database at step 1208. When stored, the incoming message and/or the media are associated with the space identified by the previous step, i.e., step 1206. Next, the server 604 may generate a visual representation of the media included with the incoming message at step 1210. In the alternative, the server 604 may generate a visual representation of a group of media including the media included with the incoming message at step 1210. The group of media, for example, may include media associated with the identified space and previously received by the server 604. The server 604 may then determine one or more destination devices 606, 608, 610 associated with the identified space at step 1212. Finally, the server 604 may send an outgoing message to the destination devices 606, 608, 610 at step 1214, and the first preferred operation ends at step 1216. The output message includes the visual representation generated at step 1210.

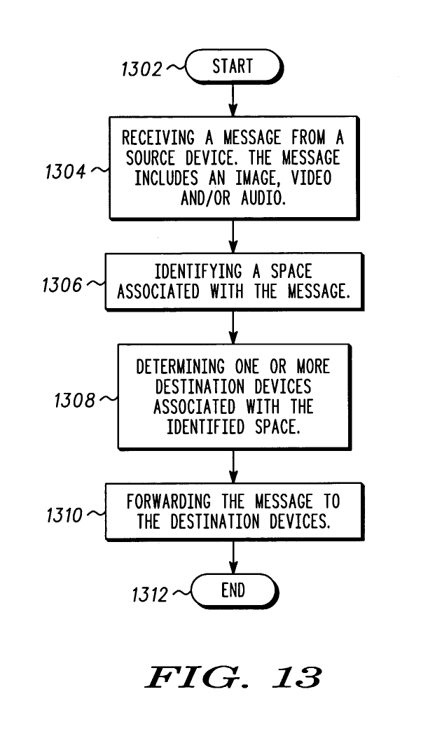

Referring to FIG. 13, there is provided a flow diagram representing the second preferred operation. For the second preferred operation, beginning at step 1302, the processor 302 of the server 804 may receive an incoming message from a source device 802 at step 1304. The incoming message includes image information, video information and/or audio information. Next, the server 804 may identify a space associated with the incoming message at step 1306. The server 804 may then determine one or more destination devices 806, 808, 810 associated with the identified space at step 1308. Finally, the server 804 may forward the incoming message and/or the media included with the incoming message to the destination devices 806, 808, 810 at step 1310, and the second preferred operation ends at step 1312.

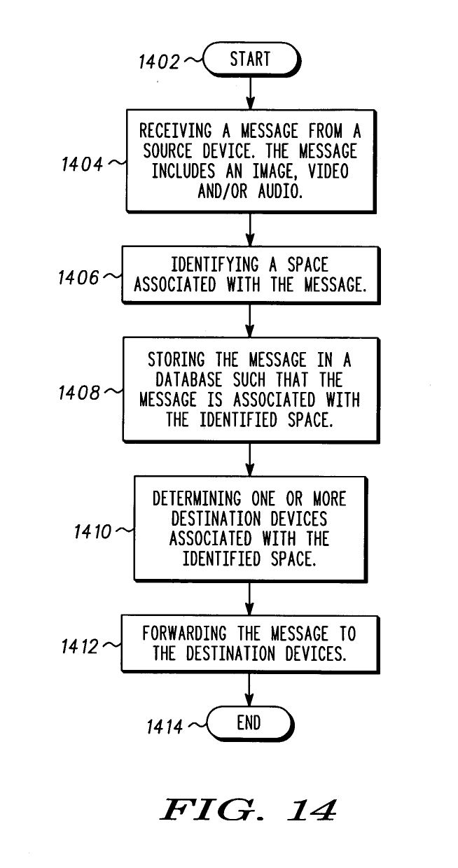

Referring to FIG. 14, there is provided a flow diagram representing the third preferred operation. For the third preferred operation, beginning at step 1402, the processor 302 of the server 1004 may receive an incoming message from a source device 1002 at step 1404. The incoming message includes image information, video information and/or audio information. Next, the server 1004 may identify a space associated with the incoming message at step 1406. The server 1004 may then store the incoming message and/or the media included with the incoming message in a database at step 1408. When stored, the incoming message and/or the media are associated with the space identified by the previous step, i.e., step 1406. The server 1004 may then determine one or more destination devices 1006, 1008, 1010 associated with the identified space at step 1410. Finally, the server 1004 may forward the incoming message and/or the media included with the incoming message to the destination devices 1006, 1008, 1010 at step 1412, and the third preferred operation ends at step 1414.

While the preferred embodiments of the invention have been illustrated and described, it is to be understood that the invention is not so limited. For example, the visual representations shown in described above in reference to the first preferred operation may also be applied to the second and third preferred operations. Numerous modifications, changes, variations, substitutions and equivalents will occur to those skilled in the art without departing from the spirit and scope of the present invention as defined by the appended claims.

What is claimed is:

1. A method for a server of communicating visual messages among a plurality of communication devices, the method comprising:
receiving an incoming message from a source device, the incoming message including a media;
associating the media with a space, the space being a grouping of media associated with a particular group of communication entities; and
sending an outgoing message to the at least one destination device, the outgoing message including a visual representation of the media.

2. The method of claim 1, wherein receiving an incoming message from a source device includes receiving the media that is at least one of image data, video data and audio data.

3. The method of claim 1, further comprising storing the media in a database such that the media is associated with the space.

4. The method of claim 1, further comprising identifying at least one destination device associated with the space.

5. The method of claim 1, wherein sending an outgoing message to the at least one destination device includes sending the visual representation as a reduced version of the media.

6. A method for a server of communicating visual messages among a plurality of communication devices, the method comprising:
receiving a message from a source device, the message including a media;
associating the media with a space, the space being a grouping of media associated with a particular group of communication entities; and
forwarding the message to the at least one destination device.

7. The method of claim 6, wherein receiving a message from a source device includes receiving the media that is at least one of image data, video data and audio data.

8. The method of claim 6, further comprising storing the media in a database such that the media is associated with the space.

9. The method of claim 6, further comprising identifying at least one destination device associated with the space.

10. The method of claim 6, wherein forwarding the message to the at least one destination device includes sending the visual representation as a reduced version of the media.

11. A server for communicating with a plurality of communication devices comprising:
a network interface configured to receive an incoming message from a source device and to send an outgoing message to at least one destination device, the incoming message including a media and the outgoing message including a visual representation of the media; and
a processor, coupled to the network interface, configured to associate the media with a space, the space being a grouping of media associated with a particular group of communication entities.

12. The server of claim 11, wherein the media is at least one of image data, video data and audio data.

13. The server of claim 11, further comprising a database configured to store the media such that the media is associated with the space.

14. The server of claim 11, wherein the processor identifies at least one destination device associated with the space.

15. The server of claim 11, wherein the visual representation is a reduced version of the media.

16. A server for communicating with a plurality of communication devices comprising:
a network interface configured to receive a message from a source device and to forward the message to at least one destination device, the message including a media; and
a processor, coupled to the network interface, configured to associate the media with a space, the space being a grouping of media associated with a particular group of communication entities.

17. The server of claim 16, wherein the media is at least one of image data, video data and audio data.

18. The server of claim 16, further comprising a database configured to store the media such that the media is associated with the space.

19. The server of claim 16, wherein the processor identifies at least one destination device associated with the space.

20. The server of claim 16, wherein the visual representation is a reduced version of the media.
